(19) United States
(12) Patent Application Publication
(10) Pub. No.: US 2025/0290452 A1
(43) Pub. Date: Sep. 18, 2025

(54) TURBINE ENGINE WITH ACCESSORY GEARBOX

(71) Applicant: General Electric Company, Evendale, OH (US)

(72) Inventors: John Carl Glessner, Kings Mills, OH (US); Stephen G. Matava, Andover, MA (US)

(21) Appl. No.: 19/220,996

(22) Filed: May 28, 2025

Related U.S. Application Data
(63) Continuation-in-part of application No. 18/461,078, filed on Sep. 5, 2023.

(51) Int. Cl. F02C 7/32; F02C 7/36

(52) U.S. Cl. CPC F02C 7/32; F02C 7/36; F05D 2220/323; F05D 2260/4031

(57) ABSTRACT

A turbine engine includes an engine core defined by a compressor section, a combustion section, and a turbine section. An inner cowl circumscribing at least a portion of the engine core is radially spaced from the engine core to define an inner cowl space. An outer cowl circumscribes at least a portion of the inner cowl. A fairing extends radially between the inner cowl and the outer cowl having at least a hollow portion. An accessory gearbox has a first portion defined by a single arm located in the inner cowl space and a second portion located in the hollow portion. A first accessory device is located in the inner cowl space and a second accessory device located in the hollow portion of the fairing.

### CROSS-REFERENCE TO RELATED APPLICATIONS

This application is a continuation-in-part application of U.S. application Ser. No. 18/461,078 filed Sep. 5, 2023, all of which is hereby incorporated by reference in its entirety.

### TECHNICAL FIELD

This disclosure relates to a turbine engine, and more specifically, to a turbine engine including a first accessory gearbox and a second accessory gearbox.

### BACKGROUND

Gas turbine engines often include an accessory gearbox to power or drive accessory systems such as fuel pumps, lubrication pumps, air compressors, scavenge pumps, electrical generators, hydraulic pumps, etc. The accessory gearbox can be driven by one or more components of the gas turbine engine. The accessory systems can require a power output having characteristics (rotational speed, torque, horsepower, etc.) that is different from that provided by the gas turbine engine. The accessory gearbox provides an interface that converts the power supplied by the gas turbine engine to something usable by the accessory systems.

### BRIEF DESCRIPTION OF THE DRAWINGS

A full and enabling disclosure, including the best mode thereof, directed to one of ordinary skill in the art, is set forth in the specification, which refers to the appended figures in which:

In the drawings:

FIG. 1 is a schematic view of a turbine engine with a dual sectional cutaway along a turbine engine axis of rotation illustrating a first accessory gearbox and a second accessory gearbox, according to aspects of the present disclosure.

FIG. 2 is a side view of the selected components of the turbine engine of FIG. 1, further illustrating the first accessory gearbox and the second accessory gearbox, according to aspects of the present disclosure.

FIG. 3 is a schematic cross-sectional view taken along line III-III of FIG. 1, according to aspects of the present disclosure.

FIG. 4 is a variation of the schematic cross-sectional view of FIG. 3, according to aspects of the present disclosure.

FIG. 5 is another variation of the schematic cross-sectional view of FIG. 3, according to aspects of the present disclosure.

FIG. 6 is a variation of the schematic cross-sectional view of FIG. 5, according to aspects of the present disclosure.

FIG. 7 is a variation of the side view of FIG. 2, further illustrating the accessory gearbox of FIG. 6, according to aspects of the present disclosure.

### DETAILED DESCRIPTION

Traditionally, accessories are located in the outer cowl space with an accessory gearbox. However, locating the accessories and the accessory gearbox in the outer cowl changes the aerodynamic line of the outer cowl. That is, the accessories and the accessory gearbox increase thickness of the outer cowl and can even result in a bulge or protrusion in the outer cowl.

Moving the first and second accessories out of the outer cowl and into another part of the engine requires multiple gearboxes. The added weight of multiple gearboxes has traditionally discouraged the use of multiple gearboxes as an increase in weight traditionally results in a decrease of overall turbine engine fuel efficiency.

This disclosure, however, illustrates a first solution that moves the first accessory and the second accessory out of the outer cowl, while including a first accessory gearbox and a second accessory gearbox in a unique configuration where little to no weight is added, and simultaneously improving the aerodynamics of the outer cowl and the overall turbine engine fuel efficiency increases.

This disclosure also illustrates a second solution that moves accessories into a unique configuration, while including an accessory gearbox that extends beyond the inner cowl to improve aerodynamics and the overall turbine engine fuel efficiency.

One or more aspects described herein provide at least one accessory gearbox (AGB) that can be a single accessory gearbox (AGB), or a first accessory gearbox (AGB1) and a second accessory gearbox (AGB2) within a turbine engine. The turbine engine includes a fan section, a compressor section, a combustion section, and a turbine section in axial flow arrangement. The compressor section comprises a low-pressure compressor and a high-pressure compressor. An inner cowl circumscribes at least a portion of an engine core and is radially spaced from the engine core to define an inner cowl space. An outer cowl circumscribes at least a portion of the inner cowl, where a fairing extends between the inner cowl and the outer cowl having at least a hollow portion.

When considering the AGB1 and the AGB2, the AGB1 is located in the inner cowl space and extends into the hollow portion of the fairing. Optionally, the AGB1 extends through the fairing from the inner cowl space into the outer cowl. A first accessory device located in the inner cowl space is operably coupled to the AGB1. A second accessory device located in the hollow portion of the fairing is also operably coupled to the AGB1.

The AGB2 is located in the outer cowl is operably coupled to and spaced from the first accessory gearbox. A third accessory device is operably coupled to the second accessory gearbox and located in the outer cowl.

Alternatively, the single AGB includes a first portion located in the inner cowl space and second portion, coupled to the first portion, that extends into the hollow portion of the fairing. The second portion of the AGB that extends into the hollow portion can be located in or pass through a transition region of the fairing. A first accessory device located in the inner cowl space is operably coupled to the first portion of the AGB at a first interface. A second accessory device located in the hollow portion of the fairing is operably coupled to a second portion of the AGB at a second interface. Additional accessory devices can be operably coupled to the AGB and located in the inner cowl space or the outer cowl space. Also considered is the AGB extending through the fairing from the inner cowl space into the outer cowl.

For purposes of illustration, the present disclosure will be described with respect to a turbine engine for an aircraft. More specifically, a ducted turbofan. The ducted turbofan can be direct drive or geared. Further, the disclosure can have applicability in a variety of vehicles or engines, and can be used to provide benefits in industrial, commercial, and residential applications. Further non-limiting examples of other vehicles or engines to which the disclosure can relate can include boats, helicopters, cars, or other aquatic, air, space, or land vehicles. Industrial, commercial, or residential applications of the disclosure can include, but are not limited to, marine power plants, wind turbines, or small power plants.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

Additionally, as used herein, the terms “radial” or “radially” refer to a direction away from a common center. For example, in the overall context of a turbine engine, radial refers to a direction along a ray extending between a center longitudinal axis of the engine (turbine engine axis of rotation) and an outer engine circumference.

Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another.

The drawings are for purposes of illustration only and the dimensions, positions, order and relative sizes reflected in the drawings attached hereto can vary.

As used herein, the term “accessory gearbox (AGB)” refers to a gearbox that receives rotational input from a rotating shaft in the engine core of a turbine engine or another gearbox. The AGB provides an output to accessories such as, but not limited to, engine accessories or aircraft accessories. In other words, an AGB provides output to at least one accessory and can optionally provide a rotational output to a second AGB.

A used herein, the term “transfer gear box (TGB)” is a gearbox that provides rotational output to at least another gearbox.

As used herein, the term “aircraft accessory” refers to an accessory that can interface with components outside of the turbine engine 10, once the turbine engine 10 is self-sustaining. Optionally, aircraft accessory can contribute to the operation of the turbine engine 10 in addition to interfacing with one or more components outside of the turbine engine 10. Non-limiting examples of aircraft accessories include an electrical generator, a hydraulic pump, an aircraft permanent magnet alternator, or an air turbine starter. Further non-limiting examples can include a primary lubrication pump, secondary lubrication pump, main fuel pump, fuel boost pump, or rotisserie.

As used herein, the term “engine accessory” refers to an accessory that only contributes to the operation of the turbine engine 10. Non-limiting examples of engine accessories include a fuel pump, main fuel pump, fuel boost pump, lubrication pump, primary lubrication pump, secondary lubrication pump, air compressor, starter, air turbine starter, scavenge pump, fuel control, rotisserie, or permanent magnet alternator.

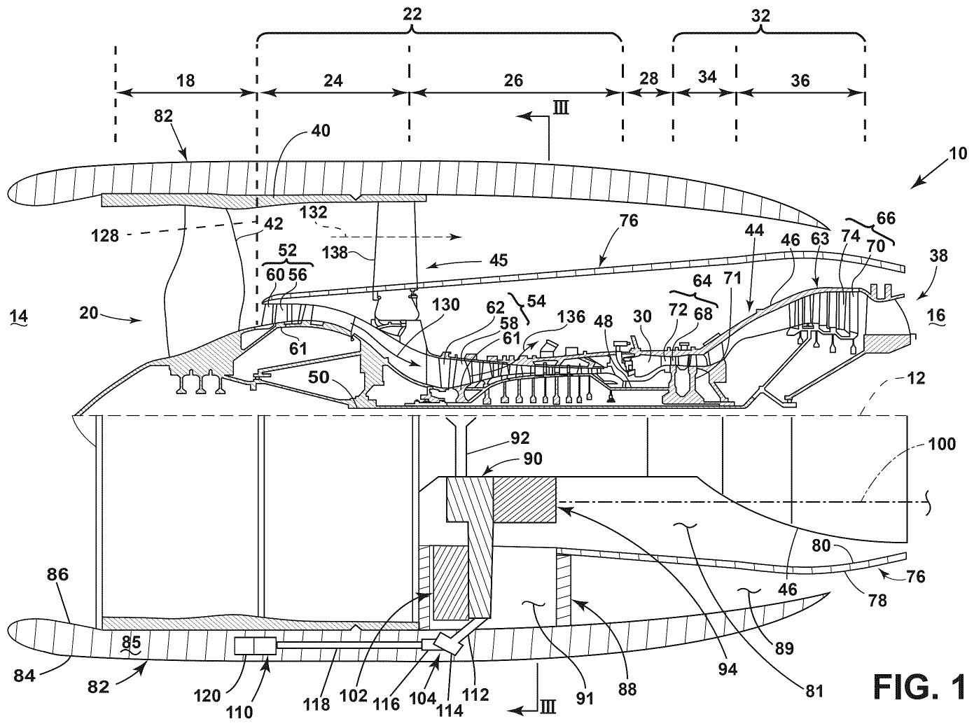

FIG. 1 is a schematic partial section view of a turbine engine 10 for an aircraft, where an upper section of FIG. 1 illustrates the cross section of the turbine engine 10 and a lower section illustrates a schematic of static support structures, an accessory gearbox, a transfer gearbox, accessory devices, and a connection assembly that couples the accessory gearbox to the transfer gearbox.

The turbine engine 10 has a centerline or turbine engine axis of rotation 12 extending forward 14 to aft 16. The turbine engine 10 includes, in axial flow arrangement, a fan section 18 including a fan assembly 20, a compressor section 22 including a booster or a low-pressure (LP) compressor 24 and a high-pressure (HP) compressor 26, a combustion section 28 including a combustor 30, a turbine section 32 including an HP turbine 34, and an LP turbine 36, and an exhaust section 38.

The fan section 18 includes a fan casing 40 surrounding the fan assembly 20. The fan assembly 20 includes a plurality of fan blades 42 disposed radially about the turbine engine axis of rotation 12. The compressor section 22, the combustor 30, and the turbine section 32 form a core illustrated as an engine core 44, which generates combustion gases. The engine core 44 is surrounded by a core casing 46, which can be coupled with the fan casing 40.

An outlet guide vane assembly 45 is located downstream of the fan blades 42. The outlet guide vane assembly 45 can be located in the fan section 18, the LP compressor 24, or axially span a portion of the fan section 18 and a portion of the LP compressor 24.

An HP shaft or HP spool 48 disposed coaxially about the turbine engine axis of rotation 12 of the turbine engine 10 drivingly connects the HP turbine 34 to the HP compressor 26. An LP shaft or LP spool 50, which is disposed coaxially about the turbine engine axis of rotation 12 of the turbine engine 10 within the larger diameter annular HP spool 48, drivingly connects the LP turbine 36 to the LP compressor 24 and fan assembly 20. The HP spool 48 and LP spool 50 are rotatable about the turbine engine axis of rotation 12 and couple to a plurality of rotatable elements, which can collectively define an inner rotor/stator. While illustrated as a rotor, it is contemplated that the inner rotor/stator can be a stator.

The LP compressor 24 and the HP compressor 26 respectively include a plurality of compressor stages 52, 54, in which a set of compressor blades 56, 58 rotate relative to a corresponding set of static compressor vanes 60, 62, which can also be called a nozzle, to compress or pressurize the stream of fluid passing through the stage. In a single compressor stage 52, 54, multiple compressor blades 56, 58 can be provided in a ring and can extend radially outwardly relative to the turbine engine axis of rotation 12, from a blade platform to a blade tip, while the corresponding static compressor vanes 60, 62 are positioned upstream of and adjacent to the rotating compressor blades 56, 58. It is noted that the number of blades, vanes, and compressor stages shown in FIG. 1 were selected for illustrative purposes only, and that other numbers are possible.

The compressor blades 56, 58 for a stage of the compressor can be mounted to a disk 61, which is mounted to the corresponding one of the HP spool 48 and LP spool 50, with each stage having its own disk 61. The vanes 60, 62 for a stage of the compressor section 22 can be mounted to the core casing 46 in a circumferential arrangement.

The HP turbine 34 and the LP turbine 36, respectively, include a plurality of turbine stages 64, 66, in which a set of turbine blades 68, 70 are rotated relative to a corresponding set of static turbine vanes 72, 74, which can also be called a nozzle, to extract energy from the stream of fluid passing through the stage. In a single turbine stage 64, 66, multiple turbine blades 68, 70 can be provided in a ring and can extend radially outwardly relative to the turbine engine axis of rotation 12, from a blade platform to a blade tip, while the corresponding static turbine vanes 72, 74 are positioned upstream of and adjacent to the rotating turbine blades 68, 70. It is noted that the number of blades, vanes, and turbine stages shown in FIG. 1 were selected for illustrative purposes only, and that other numbers are possible.

The turbine blades 68, 70 for a stage of the turbine section 32 can be mounted to a disk 71, which is mounted to the corresponding one of the HP spool 48 and LP spool, 50, with each stage having a dedicated disk 71. The turbine vanes 72, 74 for a stage of the turbine section 32 can be mounted to the core casing 46 in a circumferential arrangement.

Complementary to the rotor portion, the stationary portions of the turbine engine 10, such as the static compressor vanes 60, 62, and the static turbine vanes 72, 74 among the compressor and turbine sections 22, 32 are also referred to individually or collectively as a stator 63. As such, the stator 63 can refer to the combination of non-rotating elements throughout the turbine engine 10.

An inner cowl 76 is radially spaced from the engine core 44 and can circumscribe at least a portion of the engine core 44. The inner cowl 76 can include an outside face 78 and an inside face 80, where the inside face 80 of the inner cowl 76 can confront the engine core 44 or the core casing 46.

An inner cowl space 81 is defined between at least a portion of the engine core 44 and the inner cowl 76. More specifically, the inner cowl space 81 is the region or space between the core casing 46 and the inside face 80 of the inner cowl 76.

A nacelle or outer cowl 82 is radially spaced from the inner cowl 76 and can circumscribe at least a portion of the inner cowl 76. The outer cowl 82 has a radially outer surface 84 and a radially inner surface 86, where the radially inner surface 86 confronts the outside face 78 of the inner cowl 76. The radially outer surface 84 and the radially inner surface 86 define an outer cowl space 85. The outer cowl 82 can support or define the fan casing 40.

A strut or a fairing 88 extends radially from the inner cowl 76 to the outer cowl 82. That is, the fairing 88 radially extends or spans a bifurcated airflow path 89 between the inner cowl 76 and the outer cowl 82. The fairing 88 is illustrated, by way of example, as located in the compressor section 22. It is contemplated, however, that a portion of the fairing 88 can extend into the fan section 18 or the combustion section 28. Optionally, the fairing 88 is axially located downstream of the fan casing 40 or the outlet guide vane assembly 45. The fairing 88 connects or couples the inner cowl 76 and the outer cowl 82. More specifically, the fairing 88 can couple the inner cowl space 81 with the outer cowl space 85. In other words, the fairing 88 can include a hollow portion 91 extending between the inner cowl 76 and the outer cowl 82.

A first accessory gearbox (AGB1) 90 extends from the inner cowl space 81 into the hollow portion 91 of the fairing 88. Optionally, the AGB1 90 can extend from the inner cowl space 81, through the hollow portion 91 of the fairing 88, and into the outer cowl space 85. The AGB1 90 is axially located upstream of the turbine section 32 and downstream of the fan section 18, the LP compressor 24, or the outlet guide vane assembly 45. One or more shafts 92 and one or more gears (not shown) can operably couple the AGB1 90 to the HP spool 48 or the LP spool 50.

A first accessory device 94 is coupled to the AGB1 90. The first accessory device 94 is located radially between the core casing 46 and the inner cowl 76. The first accessory device 94 is located upstream of the combustion section 28 or the turbine section 32. Locating both the first accessory device 94 and the AGB1 90 upstream of the combustion section 28 or the turbine section 32 provides temperature benefits.

As illustrated, by way of example, the first accessory device 94 is axially downstream of the AGB1 90. Alternatively, it is contemplated that the first accessory device 94 can be radially offset and axially align with at least a portion of the AGB1 90. In yet another different and non-limiting example, the first accessory device 94 can extend or be located upstream of the AGB1 90.

Alternatively, it is further contemplated in a differing and non-limiting example, that the first accessory device 94 can be a set of first accessory devices that can include aircraft accessories, engine accessories, or a combination therein. The set of first accessory devices are located upstream of the combustion section 28 and can be located downstream, upstream, or at least partially axially align with the AGB1 90. For example, the set of first accessory devices can include two accessory devices where one accessory device is located downstream of the AGB1 90 and the other accessory device is axially aligned with the AGB1 90 or is located circumferentially on either side of the AGB1 90.

The first accessory device 94 is illustrated, by way of example, as an aircraft accessory having communication with an aircraft by a communication line 100. The first accessory device 94 or the set of first accessory devices located within the inner cowl space 81 can be, by way of non-limiting example, one or more of a starter, a hydraulic pump, or an electric generator. The electrical generator can be, by way of non-limiting example, a variable frequency generator. The starter, by way of example, can be a pneumatic starter or air turbine starter.

A second accessory device 102 is coupled to the AGB1 90. The second accessory device 102 is located in the hollow portion 91 of the fairing 88. The second accessory device 102 is located upstream of the combustion section 28 or the turbine section 32. Locating both the second accessory device 102 and the AGB1 90 upstream of the combustion section 28 or the turbine section 32 provides temperature benefits.

While illustrated as located in the hollow portion 91 of the fairing, it is contemplated that the second accessory device 102 can be partially located or otherwise extend into the inner cowl space 81.

As illustrated, by way of example, the second accessory device 102 is axially upstream of the AGB1 90. Alternatively, it is contemplated that the second accessory device 102 can extend or be located downstream of the AGB1 90. In yet another different and non-limiting example, the second accessory device 102 can be radially offset and axially align with at least a portion of the AGB1 90.

Alternatively, it is further contemplated in a differing and non-limiting example, that the second accessory device 102 can be a set of second accessory devices that can include aircraft accessories, engine accessories, or a combination therein. The set of second accessory devices are located upstream of the combustion section 28 and can be located downstream, upstream, or at least partially axially align with the AGB1 90. For example, the set of second accessory devices can include two accessory devices where one accessory device is located downstream of the AGB1 90 and the other accessory device is axially aligned with the AGB1 90 or is located circumferentially on either side of the AGB1 90.

The second accessory device 102 or the set of secondary accessory devices can be an aircraft accessory, an engine accessory, or any combination therein. The second accessory device 102 can be by way of non-limiting example, a lubrication pump.

A connection assembly 104 or a transfer gearbox (TGB) operably couples the AGB1 90 to a second accessory gearbox (AGB2) 110. The connection assembly 104 can include a first transfer shaft 112, a first interface 114, a second interface 116, and a second transfer shaft 118. The first transfer shaft 112 can extend radially from the AGB1 90 toward the outer cowl 82. The first transfer shaft 112 can pass through the hollow portion 91 of the fairing 88. In a different and non-limiting example, the connection assembly 104 that operably couples the AGB1 90 to the AGB2 110 can include a series of interlocking gears (not shown). Further, it is contemplated that any number of shafts, gears, or other elements can couple the AGB1 90 to the AGB2 110 to provide a rotational output from the AGB1 90 received as rotational input at the AGB2 110.

Alternatively, in a different and non-limiting example, the AGB1 90 can extend into the outer cowl space 85 and provide a rotational output to the second transfer shaft 118 to drive the AGB2 110.

The AGB2 110 is coupled to the second transfer shaft 118 and receives rotational energy from the second transfer shaft 118. The AGB2 110 is located upstream of the combustion section 28. However, as illustrated by way of example, the AGB2 110 can be located upstream of the HP compressor section 26. That is, the AGB2 110 can be located in the fan section 18, axially adjacent an upstream portion of the LP compressor 24, or combination thereof.

A third accessory device 120 is coupled to the AGB2 110. The third accessory device 120 is located upstream of the combustion section 28. The third accessory device 120 can also be upstream of the fairing 88 or upstream of at least a portion of the outlet guide vane assembly 45. That is, one or more portions of the third accessory device 120 can be located in the fan section 18, axially overlapping an upstream portion of the LP compressor 24, or combination thereof. By way of non-limiting example, the third accessory device 120 can axially overlap the fan casing 40. Having the AGB2 110 or the third accessory device 120 upstream of the combustion section 28 and radially spaced from the engine core 44 provides a cooler environment than a radially or axially location closer to the combustion section 28.

The third accessory device 120 is located in the outer cowl space 85. As illustrated, by way of example, the third accessory device 120 is axially upstream of the AGB2 110. Alternatively, it is contemplated that the third accessory device 120 can be radially offset and axially align with at least a portion of the AGB2 110. In yet another different and non-limiting example, the third accessory device 120 can extend or be located downstream of the AGB2 110. That is, the third accessory device 120 can extend from any one or more portions of the AGB2 110 in any radial, axial, or circumferential arrangement such that the AGB2 110 provides an output to the third accessory device 120 in the outer cowl 82. It is also contemplated that the third accessory device 120 can axially overlap at least a portion of the fan blades 42.

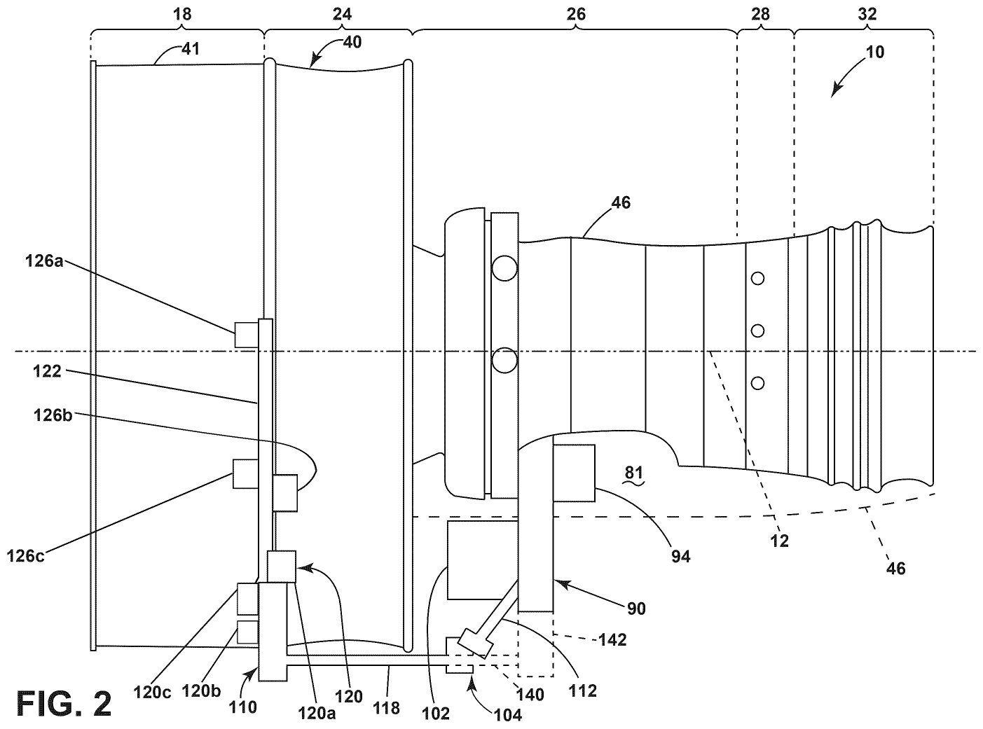

Alternatively, it is further contemplated in a differing and non-limiting example, that the third accessory device 120 can be a set of third accessory devices (see FIG. 2) that can include aircraft accessories, engine accessories, or a combination therein. The set of third accessory devices 120 are located in the outer cowl space 85 upstream of the HP compressor 26 or the combustion section 28 and can be located downstream, upstream, or at least partially axially align with the AGB2 110.

The third accessory device 120 or the set of third accessory devices can include one or more of a fuel pump, scavenge pump, fuel metering device, fuel boost pump, permanent magnet alternator, engine turning motor, or rotisserie.

In operation, air flows through the fan section 18 to an inlet 128 that is defined by the fan assembly 20. Airflow exiting the fan section 18 through the inlet 128 enters a bifurcated airflow path. The bifurcated airflow path includes a first airflow 130 through the engine core 44 and a second airflow 132 through the bifurcated airflow path 89. Therefore, the inlet 128 can be fluidly coupled to the engine core 44 and the bifurcated airflow path 89.

The first airflow 130 is channeled into the LP compressor 24 where it is pressurized (hereinafter referred to as “a pressurized airflow 130”), which then supplies the pressurized airflow 130 to the HP compressor 26, which further pressurizes the pressurized airflow 130. The pressurized airflow 130 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the turbine engine 10 via the exhaust section 38. The driving of the LP turbine 36 drives the LP spool 50 to rotate the fan assembly 20 and the LP compressor 24.

A portion of the pressurized airflow 130 can be drawn from the compressor section 22 as bleed air 136. The bleed air 136 can be drawn from the pressurized airflow 130 and provided to engine components requiring cooling. The temperature of pressurized airflow 130 entering the combustor 30 is significantly increased. As such, cooling provided by the bleed air 136 is necessary for operating of such engine components in the heightened temperature environments.

The second airflow 132 travels through the bifurcated airflow path 89 (hereinafter, secondary airflow path 89) defined by the inner cowl 76 and the outer cowl 82. That is, the outside face 78 of the inner cowl 76 and the radially inner surface 86 of the outer cowl 82 can define the secondary airflow path 89.

The second airflow 132 bypasses the engine core 44 and exits the turbine engine 10. The secondary airflow path 89 can include a stationary vane row, and more particularly the outlet guide vane assembly 45, that includes a plurality of airfoil guide vanes 138. More specifically, a circumferential row of radially extending airfoil guide vanes 138 are utilized adjacent the fan section 18 to exert some directional control of the second airflow 132.

Some of the air supplied by the fan assembly 20 can bypass the engine core 44 and be used for cooling of portions, especially hot portions, of the turbine engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

As the LP spool 50 or the HP spool 48 rotate, rotational energy is provided to the AGB1 90 by the one or more shafts 92. The AGB1 90 provides rotational output to the first accessory device 94, the second accessory device 102, and the connection assembly 104 or the second transfer shaft 118. The connection assembly 104 or the second transfer shaft 118 then rotates one or more portions of the AGB2 110, which is operably coupled to the third accessory device 120.

FIG. 2 is a schematic side view of the turbine engine 10 wherein the outer cowl 82, the inner cowl 76, and the fairing 88 (FIG. 1) are removed for ease of understanding.

The third accessory device 120 is illustrated as a set of third accessory devices 120a, 120b, 120c, operably coupled to the AGB2 110. While illustrated as having three accessory devices, the set of third accessory devices 120a, 120b, 120c can include any number of accessory devices.

It is contemplated that at least a subset of the set of third accessory devices 120a, 120b, 120c can be mounted to an exterior 41 of the fan casing 40 located at the radially inner surface 86 (FIG. 1) of the outer cowl 82 (FIG. 1). The set of third accessory devices 120a, 120b, 120c can be axially located in one or more of the fan section 18 or the LP compressor 24 (FIG. 1). That is, the set of third accessory devices 120a, 120b, 120c are upstream of the combustion section 28 and the turbine section 32. Further, the set of third accessory devices 120a, 120b, 120c can be upstream of the HP compressor 26.

Connecting accessories, illustrated as connecting accessories 126a, 126b, 126c can be located in the outer cowl space 85 (FIG. 1) on the exterior 41 of the fan casing 40, for example. The connecting accessories 126a, 126b, 126c can couple to one or more of the set of third accessory devices 120a, 120b, 120c. Connecting accessories 126a, 126b, 126c can include, by way of non-limiting example, a fuel filter, heat exchanger, a monitoring device, or a metering device.

Optionally, a coupling mechanism 122 can provide communication, fluid flow, or transfer of power between the one or more of the connecting accessories 126a, 126b, 126c and one or more of the set of third accessory devices 120a, 120b, 120c.

The first accessory device 94, the second accessory device 102, or both the first accessory device 94 and the second accessory device 102 are larger than at least one device of the set of third accessory devices 120a, 120b, 120c. It is contemplated that a volume of the at least one device of the set of third accessory devices 120a, 120b, 120c is in a range of 2% to 66% of a volume of the first accessory device 94, a volume of the second accessory device 102, or a volume of the first accessory device 94 and a volume of the second accessory device 102. More specially, the at least one device of the set of third accessory devices 120a, 120b, 120c is in a range of 2% to 45% of the volume of the first accessory device 94, the volume of the second accessory device 102, or the volume of the first accessory device 94 and the volume of the second accessory device 102.

It is further contemplated that every device of the set of third accessory devices 120a, 120b, 120c is in a range of 1% to 90% of the volume of the first accessory device 94, the volume of the second accessory device 102, or the volume of the first accessory device 94 and the volume of the second accessory device 102.

The AGB1 90 is larger than the AGB2 110. It is contemplated that a volume of the AGB2 is in a range from 10% to 80% of a volume of the AGB1. More specifically, the AGB2 is in a range from 15% to 66% of the volume of the AGB1.

The AGB2 110 is a mini accessory gearbox. As used herein “mini” means that the component referenced with the term mini is smaller than the corresponding like component without the term mini (i.e., the mini accessory gearbox 110 is smaller than the AGB1 90).

The first transfer shaft 112 extending from the AGB1 90 operably couples to the second transfer shaft 118. Optionally, a portion 140 of the second transfer shaft 118 can couple to a portion 142 of the AGB1 90. That is, the AGB1 90 can directly drive the second transfer shaft 118.

While AGB1 90 and AGB2 110 are illustrated as coupled by the first transfer shaft 112, the connection assembly 104, and the second transfer shaft 118, any number of gears or shafts are contemplated to operably couple the AGB2 and the AGB1. That is, it is contemplated that a series of gears can extend from AGB1 to AGB2 to provide AGB2 with rotation energy.

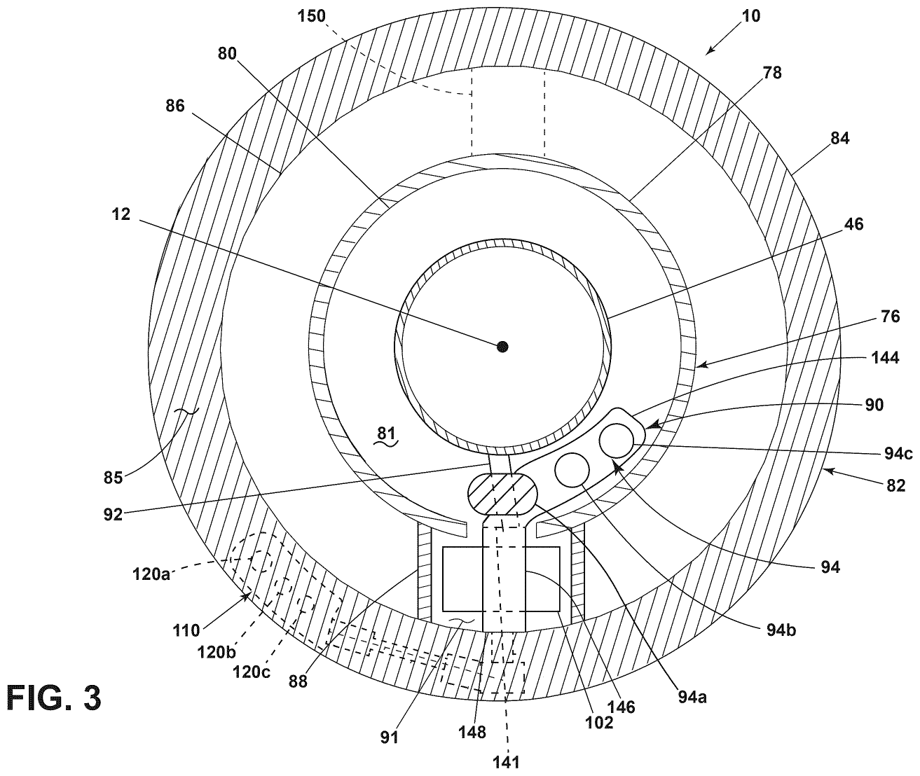

FIG. 3 is a schematic cross-section of the turbine engine 10 taken along the line III-III of FIG. 1. The AGB1 90 includes a first portion 144 and a second portion 146. The first portion 144 of the AGB1 90 is located between the core casing 46 and the inside face 80 of the inner cowl 76. The first portion 144 curves or arcs about the turbine engine axis of rotation 12 or the engine core 44 (FIG. 1) radially outside of the core casing 46.

The second portion 146 of the AGB1 90 extends from the first portion 144 into the fairing 88. While illustrated as having an end 148 located in the hollow portion 91 of the fairing 88, it is contemplated that the end 148 can extend past the radially inner surface 86 of the outer cowl 82.

An intersection 141 or transition can be defined where the second portion 146 extends from the first portion 144. The one or more shafts 92 can couple to the AGB1 90 at or adjacent the intersection 141. The rotational energy provided by the one or more shafts 92 to the AGB1 90 can be used to drive or operate the first accessory device 94 and the second accessory device 102 by a series of gears or the combination of gears and shafts.

The first accessory device 94 is illustrated as a set of first accessory devices 94a, 94b, 94c. The set of first accessory devices 94a, 94b, 94c are located radially between the core casing 46 and the inside face 80 of the inner cowl 76. The set of first accessory devices 94a, 94b, 94c are operably coupled to the first portion 144 of the AGB1 90.

The set of first accessory devices 94a, 94b, 94c are illustrated, by way of example, as having an oval or circular cross section, however any cross-sectional shape is contemplated. By way of non-limiting example, the first accessory device 94 cross-sectional shape can be rectangular, trapezoidal, regular polygon, irregular polygon, or any combination thereof.

By way of example, the set of first accessory devices 94a, 94b, 94c can include at least one or more of a variable frequency generator, a hydraulic pump, and a starter.

Locating a variable frequency generator in the inner cowl space 81 instead of between the radially outer surface 84 and the radially inner surface 86 of the outer cowl 82, provides the benefit of decreasing drag and improving the aerodynamics of the outer cowl 82. The variable frequency generator is generally a larger accessory and by locating it in the inner cowl space 81 instead of the outer cowl space 85, the inner cowl 76 and the outer cowl 82 can be more streamlined or aerodynamic when the variable frequency generator is within the outer cowl space 85. Having a leaner or more aerodynamic inner cowl 76 and outer cowl 82 can reduce the overall diameter of the turbine engine 10.

Locating the hydraulic pump in the inner cowl space 81 instead of the outer cowl space 85 decreases drag, improves the aerodynamics of the outer cowl 82, and reduces overall weight. When located in the outer cowl space 85, additional tubing is required to provide hydraulic services from the hydraulic pump to the engine core 44 (FIG. 1). By locating the hydraulic pump in the inner cowl space 81, less tubing is needed which provides a weight savings and a material savings.

Locating a starter in the inner cowl space 81 instead of the outer cowl space 85 decreases drag, improves the aerodynamics of the outer cowl 82, and reduces overall weight by minimizing the required air duct length.

The second accessory device 102 operably couples to the second portion 146 of the AGB1 90. The second accessory device 102 can be a lubrication pump. Locating the lubrication pump in the hollow portion 91 of the fairing 88 instead of the outer cowl space 85 decreases drag, improves the aerodynamics of the outer cowl 82, and reduces overall weight by reducing the length of lubrication lines. Further, locating the lubrication pump in the fairing 88 is a cooler environment than the inner cowl space 81. Additional benefits to locating the lubrication pump in the fairing 88 include maintaining or improving the aerodynamics of both the outer cowl 82 and the inner cowl 76.

While illustrated as extending through the fairing 88 at a lower portion of the turbine engine 10, it is contemplated that the AGB1 90 could extend through a different fairing, such as an upper fairing 150.

The set of third accessory devices 120a, 120b, 120c are operably coupled to the mini accessory gearbox (AGB2 110). The set of third accessory devices 120a, 120b, 120c, are smaller than the set of first accessory devices 94a, 94b, 94c and the second accessory device 102. The set of third accessory devices 120a, 120b, 120c can include one or more of a fuel pump, a permanent magnet alternator, or an engine turning motor.

Locating the fuel pump in the outer cowl space 85 provides a cooler environment. Further, locating the fuel pump in the outer cowl space 85 at the fan casing 40 (FIG. 1), allows for easy accessibility. Connecting accessories 126a, 126b, 126c (FIG. 2) can be coupled to the fuel pump and can also be located in the outer cowl space 85 which is a cooler environment.

Locating the permanent magnet alternator in the outer cowl space 85 provides the permanent magnet alternator closer to the full authority digital engine control reducing harness weight. Locating the permanent magnet alternator in the outer cowl space 85 places the permanent magnet alternator in an environment that requires less shielding when compared to the inner cowl space 81. It is also contemplated that the coating on the wires could be thinner when located in the outer cowl space 85 as compared with the inner cowl space 81.

Locating the engine turning motor in the outer cowl space 85 provides the engine turning motor closer to the full authority digital engine control. Locating the engine turning motor closer to the full authority digital engine control reduces harness weight.

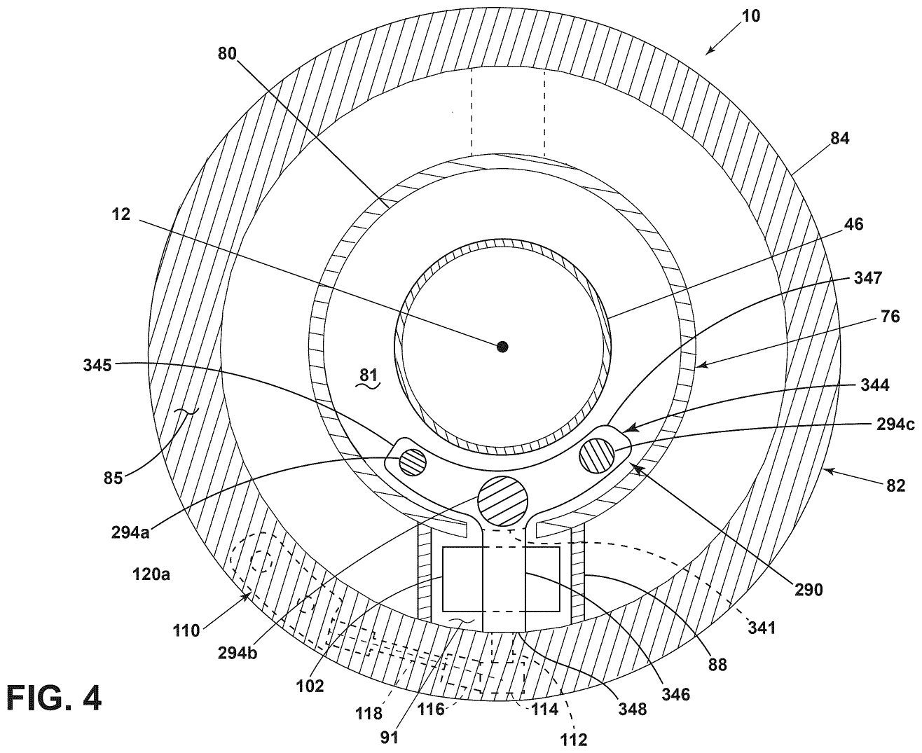

FIG. 4 is a variation of the schematic cross-section of the turbine engine 10 of FIG. 3 illustrating a first accessory gearbox (AGB1) 290. The AGB1 290 is similar to the AGB1 90 (FIG. 1), therefore, like parts of the AGB1 290 will be identified with like numerals increased by 200, with it being understood that the description of the like parts of the AGB1 90 applies to the AGB1 290, except where noted.

The AGB1 290 includes a first portion 344 and a second portion 346. The first portion 344 is located in the inner cowl space 81 that is the region or space between the core casing 46 and the inside face 80 of the inner cowl 76. The first portion 344 includes a first arm 345 and a second arm 347. The first arm 345 and the second arm 347 can straddle or wrap around different portions of the turbine engine axis of rotation 12 or the core casing 46. The first arm 345 and the second arm 347 can form a U-shape, as illustrated. However, it is contemplated that the first arm 345 and the second arm 347 can form a V-shape. It is contemplated that the first arm and the second arm straddle the engine core.

While illustrated as symmetric, it is contemplated that the first arm 345 and the second arm 347 extend different arc-lengths about the core casing 46.

The second portion 346 extends from the first portion 344 at an intersection 341. While illustrated as in the inner cowl space 81, it is contemplated that the intersection 341 can be in the hollow portion 91 of the fairing 88.

A set of first accessory devices 294a, 294b, 294c can couple to one or more portions of the first arm 345 or the second arm 347. As illustrated, by way of example, the set of first accessory devices 294a, 294b, 294c can include at least one device 294b located at the intersection of the first arm 345 and the second arm 347. While illustrated as coupling to the first portion 344 at the inner cowl space 81, it is contemplated that one or more portions of one of more of the set of first accessory devices 294a, 294b, 294c can extend into the hollow portion 91 of the fairing 88.

The second accessory device 102 operably couples to the second portion 346 of the AGB1 290. While illustrated as coupling to the second portion 346 at the hollow portion 91 of the fairing 88, it is contemplated that one or more portions of one of more of the second accessory device 102 can extend into the inner cowl space 81 or the outer cowl space 85.

An end 348 of the second portion 346 can couple to the first transfer shaft 112 which transfers rotational energy from the AGB1 290 to the AGB2 110 by way of the first interface 114, the second interface 116, and the second transfer shaft 118. However, it is contemplated, in a different and non-limiting example, that the end 348 of the AGB1 290 can extend into the outer cowl space 85. Further, it is contemplated in another different and non-limiting example that the transfer of energy from the AGB1 290 to the AGB2 110 can be completed using any number of shafts, transfer gearboxes, connecting interfaces, or gears.

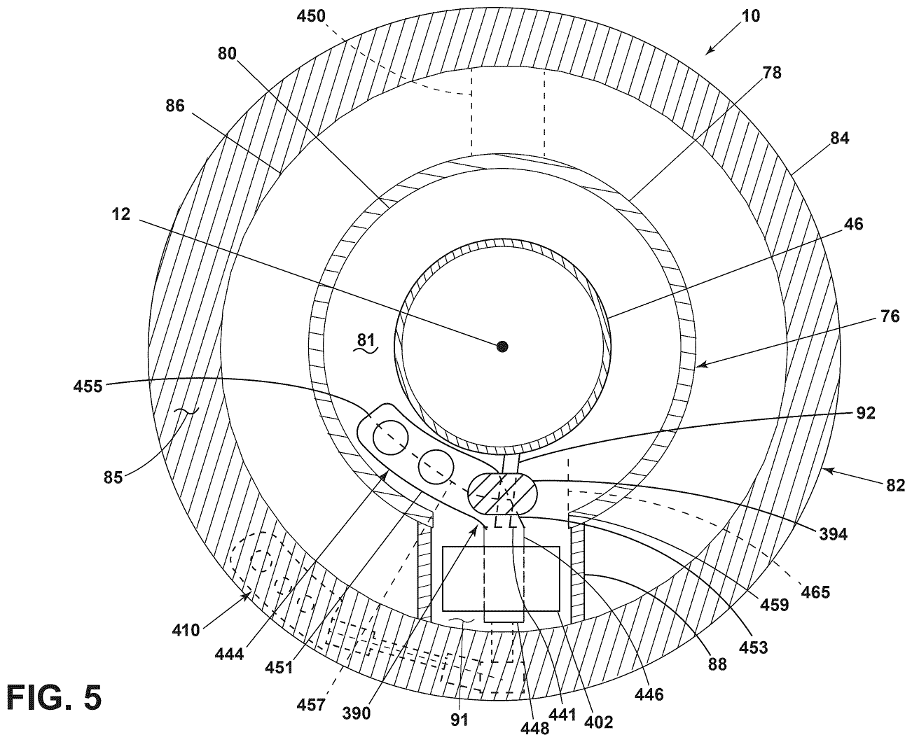

FIG. 5 is another variation of the schematic cross-section of the turbine engine 10 of FIG. 3 illustrating a first accessory gearbox (AGB1) 390. The AGB1 390 is similar to the AGB1 90 (FIG. 1), therefore, like parts of the AGB1 390 will be identified with like numerals increased by 300, with it being understood that the description of the like parts of the AGB1 90 applies to the AGB1 390, except where noted.

The AGB1 390 includes a first portion 444 and a second portion 446. The first portion 444 of the AGB1 390 is located between the core casing 46 and the inside face 80 of the inner cowl 76.

Similar to the first portion 144 (FIG. 3) of the AGB1 90 (FIG. 3), the first portion 444 of the AGB1 390 includes a single arm 451. That is, the first portion 444 of the AGB1 390 includes only one arm; the single arm 451. The single arm 451 arcs about the core casing 46 or the turbine engine axis of rotation 12 in a single direction from the second portion 446. The single arm 451 extends from a first circumferential end 453 to an arc terminating point or second circumferential end 455. That is, the single arm 451 has a C-shape from the first circumferential end 453 to the second circumferential end 455.

A centerline 457 is defined by the single arm 451 and extends from the first circumferential end 453 to the second circumferential end 455. The single arm 451 can have an arm length measured along the centerline 457 from the first circumferential end 453 to the second circumferential end 455. That is, the arm length of the single arm 451 measures the arc length of the first portion 444 from the first circumferential end 453 to the second circumferential end 455. The single arm 451 has an arm length in a range from 1% to 80% of a circumference of the core casing 46, wherein the circumference of the core casing 46 is measured at an outer surface of the core casing 46. Within the aforementioned range of 1% to 80%, the AGB1 390 maintains accessibility for maintenance. For example, the single arm length can be in a range of 5% to 60% of the circumference of the core casing 46. Within the aforementioned range of 5% to 60%, the AGB1 390 maintains both accessibility for maintenance and provides additional space for other engine accessories. It is further contemplated that the arm length can be in a range from 5% to 50% of the circumference of the engine casing 46. Within the range of 5% to 50%, the AGB1 1890 maintains accessibility for maintenance, provides additional space for other engine accessories, and can provide a weight savings.

The single arm 451 extends in one direction from the fairing 88. By way of non-limiting example, the single arm 451, as illustrated, arcs about the core casing 46 in a clockwise direction from the first circumferential end 453 to the second circumferential end 455. An opening 459 in the inner cowl 76 allows the second portion 446 of the AGB1 390 to extend into the hollow portion 91 of the fairing 88. The opening 459 connects the inner cowl space 81 and the hollow portion 91 of the fairing 88. A boundary 465 is defined by a portion of the inner cowl 76 at the opening 459 that is adjacent the first circumferential end 453. That is, the intersection of the fairing 88 and the inner cowl 76 closest to the first circumferential end 453 can define the boundary 465. The first circumferential end 453 of the single arm 451 is spaced from the boundary 465. That is, the single arm 451 does not circumferentially extend past the boundary 465.

The second portion 446 of the AGB1 390 extends from the first portion 444 into the fairing 88. While illustrated as having an end 448 located in the hollow portion 91 of the fairing 88, it is contemplated that the end 448 can extend radially past the radially inner surface 86 of the outer cowl 82 with respect to the axis of rotation 12.

An intersection 441 is defined where the second portion 446 extends from the first portion 444. The one or more shafts 92 can couple to the AGB1 390 along or adjacent to the intersection 441. Rotational energy provided by the one or more shafts 92 to the AGB1 390 can be used to drive or operate the first accessory device 394 and the second accessory device 402 by a series of gears or the combination of gears and shafts. By way of example, the first accessory device 394 coupled to the first portion 444 of the AGB1 390 can be one or more of a variable frequency generator, a hydraulic pump, or a starter.

For example, locating a variable frequency generator in the inner cowl space 81 instead of between the radially outer surface 84 and the radially inner surface 86 of the outer cowl 82, provides the benefit of decreasing drag and improving the aerodynamics of the outer cowl 82. The variable frequency generator is a larger accessory. By locating the variable frequency generator in the inner cowl space 81 instead of the outer cowl space 85, the inner cowl 76 and the outer cowl 82 can be more streamlined or aerodynamic than when the variable frequency generator is within the outer cowl space 85. Having a leaner or more aerodynamic inner cowl 76 and outer cowl 82 can reduce the overall diameter of the turbine engine 10.

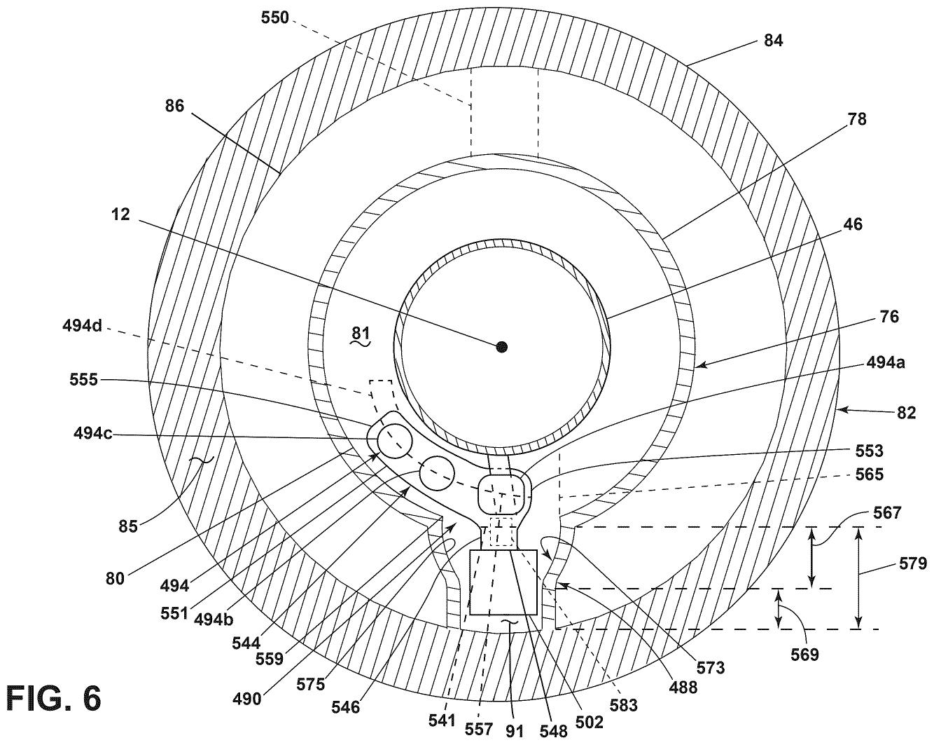

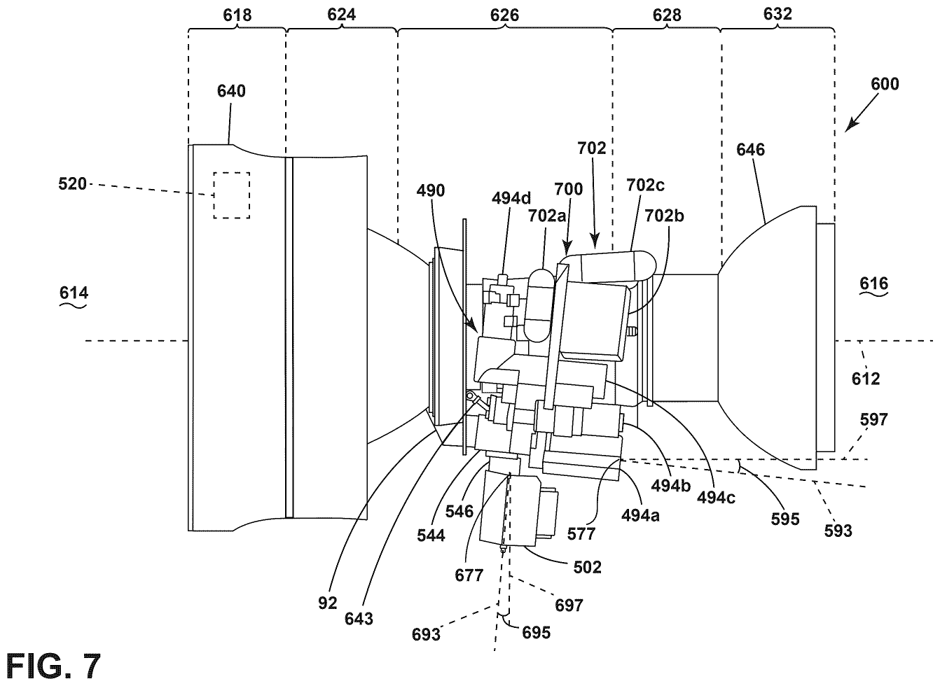

The second accessory device 402 operably couples to the second portion 446 of the AGB1 390. Unlike the second accessory device 102 (FIG. 3) of the AGB 90 (FIG. 3), the second accessory device 402 is located downstream of or aft of the second portion 446. While illustrated as downstream of or aft of the second portion 446, it is contemplated that the axial position of the second accessory device 402 can overlap with the second portion 446, as illustrated, by way of example in FIG. 6 and FIG. 7.

The second accessory device 402 can be a lubrication pump. Locating the lubrication pump in the hollow portion 91 of the fairing 88 instead of in the outer cowl space 85 decreases drag, improves the aerodynamics of the outer cowl 82, and reduces overall weight by reducing the length of lubrication lines. Further, locating the lubrication pump in the fairing 88 is a cooler environment than the inner cowl space 81. Additional benefits to locating the lubrication pump in the fairing 88 include maintaining or improving the aerodynamics of both the outer cowl 82 and the inner cowl 76.

While illustrated as extending through the fairing 88 at a lower portion of the turbine engine 10, it is contemplated that the AGB1 390 could extend through a different fairing, such as an upper fairing 450. The upper fairing 450 can extend from the inner cowl 76 to the outer cowl 82, wherein the upper fairing 450 is circumferentially spaced from the fairing 88 about the turbine engine axis of rotation 12. An angle between the upper fairing 450 and the fairing 88 or any other fairing can be in a range from 30° to 180°. The single arm 451 can be circumferentially located between the boundary 465 and the upper fairing 450. Benefits of extending through the upper fairing 450 can include reduced distance from a pylon or mounting point of the turbine engine 10 to another object, such as, but not limited to, an aircraft. Benefits of extending the AGB1 390 within the upper fairing 450 or the fairing 88 and the upper fairing 450 can include a decrease in the radial size of the AGB1 390. Additionally, or alternatively, extending into the upper fairing 450 or the upper fairing 450 and the fairing can provide additional room in the inner cowl space 81 for accessories, such as, but not limited to, environmental control systems.

Optionally, a mini accessory gearbox (AGB2 410) can operably couple to the second portion 446 of the AGB1 390. It is contemplated that any number of accessories can operably couple to the AGB2 410. The AGB2 410 can be located in the outer cowl space 85.

FIG. 6 is a variation of the AGB1 390 of the FIG. 3 illustrating a single accessory gearbox (AGB) 490. The AGB 490 is similar to the AGB1 90 (FIG. 3) and the AGB1 390 (FIG. 5) therefore, like parts of the AGB 490 will be identified with like numerals increased by 400, with it being understood that the description of the like parts of the AGB1 90 and the AGB1 390 applies to the AGB 490, except where noted.

The AGB 490 includes a first portion 544 and a second portion 546. The first portion 544 of the AGB 490 can be located between the core casing 46 and the inside face 80 of the inner cowl 76.

Similar to the first portion 144 (FIG. 3) of the AGB1 90 (FIG. 3) and the first portion 444 (FIG. 5) of the AGB1 390 (FIG. 5), the first portion 544 of the AGB 490 includes a single arm 551. That is, the first portion 544 of the AGB 490 includes only one arm; the single arm 551. The single arm 551 arcs about the core casing 46 or the turbine engine axis of rotation 12 in a single direction from the second portion 546. The single arm 551 extends from a first circumferential end 553 to an arc terminating point or second circumferential end 555.

A centerline 557 is defined by the single arm 551 and extends from the first circumferential end 553 to the second circumferential end 555. The single arm 551 has an arm length measured along the centerline 557 from the first circumferential end 553 to the second circumferential end 555. That is, the arm length of the single arm 551 is the arc length of the first portion 544 from the first circumferential end 553 to the second circumferential end 555.

The single arm 551 has an arm length in a range from 5% to 50% of a circumference of the core casing 46, where the circumference of the core casing 46 is measured at an outer surface of the core casing 46. It is contemplated that the single arm length measured along the centerline 557 is between 1% and 80% of the circumference of the core casing 46. Within the aforementioned range of 1% to 80%, the AGB 490 maintains accessibility for maintenance. For example, the single arm length can be in a range of 5% to 60% of the circumference of the core casing 46. Within the aforementioned range of 5% to 60%, the AGB 490 maintains both accessibility for maintenance and provides additional space for other engine accessories.

The single arm 551 extends in only one direction from a fairing 488 that couples the inner cowl 76 to the outer cowl 82. By way of non-limiting example, the single arm 551, as illustrated, arcs about the core casing 46 in a clockwise direction from the first circumferential end 553 to the second circumferential end 555. An opening 559 in the inner cowl 76 allows the second portion 546 of the AGB 490 to extend into the hollow portion 91 of the fairing 488. The opening 459 connects the inner cowl space 81 and the hollow portion 91 of the fairing 488.

The fairing 488 can extend through at a lower portion of the turbine engine 10 (FIG. 1). It is also contemplated that the AGB 490 can extend through a different fairing, such as an upper fairing 550. The single arm 551 can be circumferentially located between the boundary 565 and the upper fairing 550.

A boundary 565 is defined by a portion of the inner cowl 76 at the opening 559 that is adjacent the first circumferential end 553. That is, the intersection of the fairing 488 and the inner cowl 76 closest to the first circumferential end 553 can define the boundary 565. The first circumferential end 553 of the single arm 551 is spaced from the boundary 565. That is, the single arm 551 does not circumferentially extend past the boundary 565. The boundary 565 can be a plane defined in the radial direction and circumferential direction by a surface of the inner cowl 76 at the opening 559.

The second portion 546 of the AGB 490 extends from the first portion 544 into the fairing 488. While illustrated as having an end 548 located in the hollow portion 91 of the fairing 488, it is contemplated that the end 548 can extend past the radially inner surface 86 of the outer cowl 82.

An intersection 541 is defined where the second portion 546 extends from the first portion 544. The intersection 541 can circumferentially align with the inside face 80 of the inner cowl 76. The one or more shafts 92 are illustrated, by way of example, as being coupled to the AGB 490 at or adjacent the intersection 541. It is contemplated that the one or more shafts 92 can couple to any one or more portions of the first portion 544, the second portion 546, or both.

A single rotational input (e.g., the one or more shafts 92) provides the AGB 490 with a rotational energy that is transferred within the AGB 490 through the first portion 544 and the second portion 546 to a first accessory device, illustrated as a set of first accessory devices 494 and a second accessory device 502.

The fairing 488 or a portion of the fairing 488 can be unitarily formed with the inner cowl 76. Additionally, one or more portions of the fairing 488 can be received or mounted to the outer cowl 82. Alternatively, in another different example, the fairing 488 can be coupled to the inner cowl 76 and the outer cowl 82.

The fairing 488 includes a transition region 567 and an extension region 569. The transition region 567 is adjacent or couples to the inner cowl 82. The extension region 569 is adjacent or couples to the outer cowl 82. The transition region 567 and the extension region 569 can define the fairing 488. In a different and non-limiting example the fairing 488 can include the transition region 567, the extension region 569, and one or more other regions having an increasing cross section of the fairing 488, a decreasing cross section of the fairing 488, a uniform cross section of the fairing 488, or any combination thereof.

Within the transition region 567, sidewalls 573 that define the hollow portion 91 of the fairing 488 include at least one bend or contour 575. While described as having a curvature and/or a bend, any number or combination of geometric structures are contemplated such that the sidewalls 573 extend from the inner cowl 76. That is, the sidewalls 573 at the transition region 567 can define one or more sidewall planes that form an angle with an outer surface plane, where the outer surface plane is tangent to the outside face 78 of the inner cowl at the intersection of the fairing 488 and the inner cowl 76. In other words, the one or more sidewall planes form an angle with the outer surface plane that is greater than 90° or less than 90°. The curve or geometry of the transition region 567 allows the a portion or the entirety of the second accessory device 502 to be located in the fairing 488 and directly coupled to or extend from the AGB1 390.

The extension region 569 couples the transition region 567 to the outer cowl 82. The sidewalls 573 at the extension region 569 can define a plane that is perpendicular to a plane defined by the radially inner surface 86 of the outer cowl 82 at the intersection of the outer cowl 82 and the fairing 488. Optionally, the extension region 569 can be narrower than the extension region 569. This can improve the overall aerodynamics of the fairing 488, while improving the efficiently of the engine by housing at least a portion of the second accessory device 502 in the fairing 488.

The set of first accessory devices 494 are located between the core casing 46 and the inside face 80 of the inner cowl 76. Optionally, a portion of one or more of the set of first accessory devices 494 can extend from the inner cowl space 81 to the hollow portion 91 of the fairing 488. By way of example, the set of first accessory devices 494 are illustrated as a variable frequency generator 494a, an air starter 494b, and a fuel device such as a fuel pump 494c. Optionally, the set of first accessory devices 494 can further include a hydraulic pump 494d or other engine accessories. While illustrated as up to four accessory devices, it is contemplated that the set of first accessory devices 494 can include any number of accessory devices at least partially located in the inner cowl space 81.

For example, locating the variable frequency generator 494a in the inner cowl space 81 or the inner cowl space 81 and the hollow portion 91 instead of between the radially outer surface 84 and the radially inner surface 86 of the outer cowl 82 provides the benefit of decreasing drag and improving the aerodynamics of the outer cowl 82. The variable frequency generator 494a is generally a larger accessory and by locating it in the inner cowl space 81 instead of the outer cowl space 85, the inner cowl 76 and the outer cowl 82 can be more streamlined or aerodynamic when the variable frequency generator 494a is within the outer cowl space 85. Having a leaner or more aerodynamic inner cowl 76 and outer cowl 82 can reduce the overall diameter of the turbine engine 10 (FIG. 1).

The second accessory device 502 operably couples to the second portion 546 of the AGB 490. Unlike the second accessory device 102 (FIG. 3) of the AGB1 90 (FIG. 3) and the second accessory device 402 of the AGB1 390, the second accessory device 502 axially overlaps with the second portion 546, as illustrated, by way of example. Optionally, the end 548 of the second portion 546 can couple to a radially inward portion of the second accessory device 502.

At least a part of the second portion 546 of the AGB 490, at least part of the second accessory device 502, or a combination thereof can be located in the transition region 567 of the fairing 488. The transition region 567 can have a larger cross-sectional area than the extension region 569. The larger cross-sectional area can of the transition region 567 can accommodate larger components. Even with contours 575 in the sidewalls 573, locating the second accessory device 502, a portion of at least one first accessory device of the set of first accessory devices 494, or a combination thereof in the hollow portion 91 of the fairing, provides improved aerodynamics and packaging of accessory devices.

For example, locating the hydraulic pump 494d in the inner cowl space 81 instead of the outer cowl space 85 decreases drag, improves the aerodynamics of the outer cowl 82, and reduces overall weight. When located in the outer cowl space 85, additional tubing is required to provide hydraulic services from the hydraulic pump 494d to the engine core 44 (FIG. 1). By locating the hydraulic pump 494d in the inner cowl space 81, less tubing is needed which provides a weight savings and a material savings.

Locating the starter 494b in the inner cowl space 81 instead of the outer cowl space 85 decreases drag, improves the aerodynamics of the outer cowl 82, and reduces overall weight by minimizing the required air duct length.

While illustrated as terminating within the hollow portion 91 of the fairing 488, it is contemplated that the second portion 546 can extend into the outer cowl space 85. Additionally, or alternatively, a shaft driven by the first portion 544 or the second portion 546 can provide rotational energy to one or more components or accessories in the outer cowl space 85.

A fairing length 579 can be measured from the outside face 78 of the inner cowl 76 (e.g., where the fairing 488 meets the outside face 78 of the inner cowl 76) to the radially inner surface 86 of the outer cowl 82 (e.g., where the fairing 488 meets the radially inner surface 86 of the outer cowl 82). The fairing length 579 is illustrated as including the transition region 567 and the extension region 569. While the transition region 567 is illustrated as greater than 50% of the fairing length 579, it is contemplated that the transition region 567 can be equal to 50% or less than 50% of the fairing length 579. It is further contemplated that the fairing length 579 can include any number of transition region(s) and/or extension region(s).

Optionally, the AGB 490 can include a bevel gear system 583. Bevel gears of the bevel gear system 583 can be mounted at 90° to each other. However, it is contemplated that the bevel gears of the bevel gear system 583 can be mounted in a range from 70° to 110°. The bevel gear system 583 allows the first portion 544 of the AGB 490 to have an axis of rotation at a non-zero angle to the second portion 546 as further discussed in FIG. 7.

The bevel gear system 583 can be located at the intersection 541 of the first portion 544 and the second portion 546. The bevel gear system 583 can be located at least partially in the transition region 567. The bevel gear system 583 provides rotational energy from the AGB 490 to the second accessory device 502.

FIG. 7 is a schematic side view of an turbine engine 600 similar to the turbine engine 10 (FIG. 2) where the outer cowl 82, the inner cowl 76, and the fairing 88 (FIG. 1) or fairing 488 (FIG. 5) are removed for ease of understanding, therefore, like parts of the turbine engine 600 will be identified with like numerals increased by 600, with it being understood that the description of the like parts of the turbine engine 10 (FIG. 2) applies to the turbine engine 600, except where noted.

The turbine engine 600 includes, in axial flow arrangement, a fan section 618, an LP compressor section 624, an HP compressor section 626, a combustion section 628, and a turbine section 632. The turbine section 632 includes an HP turbine and an LP turbine. The turbine engine 600 has a centerline illustrated as a turbine engine axis of rotation 612 extending forward 614 to aft 616.

The AGB 490 couples to one or more portions of an engine casing 646 by one or more fasteners 643. The one or more fasteners 643 can include a system of structures including, but not limited to one or more of a rod, coupling structure or dampening element (e.g., shock or other structure that reduces translational energy). Additional fasteners can be used to fasten, secure, or mount one or more accessory devices to the AGB 490.

The one or more shafts 92 and one or more gears (not shown) can operably couple the AGB 490 the HP spool 48 (FIG. 1) or the LP spool 50 (FIG. 1). The AGB 490 can receive rotational energy from one or more portions of the LP compressor section 624, the HP compressor section 626, the turbine section 632, or any combination thereof via the one or more shafts 92.

As illustrated, by way of example, the one or more shafts 92 can couple to the first portion 544 of the AGB 490. Optionally, the one or more shafts 92 can couple to the AGB 490 at the second portion 546 or the intersection of the first portion 544 and the second portion 546.

The set of first accessory devices 494 are illustrated as the variable frequency generator 494a, the air starter 494b, the fuel pump 494c, and the hydraulic pump 494d. While illustrated as aft of the AGB490, it is contemplated that any one or more of the variable frequency generator 494a, the air starter 494b, the fuel pump 494c, or other devices of the set of first accessory devices 494 can be located forward of the AGB490 or at least partially axially overlap part of the AGB 490. While illustrated as axially overlapping the AGB 490, it is contemplated that the hydraulic pump 494d or any other accessory device of the set of first accessory devices 494 can be located forward or aft of the AGB 490.

A first intersection 577 is defined by the intersection of the variable frequency generator 494a and the first portion 544 of the AGB 490. A first drive axis 593 can be defined by the first intersection 577 or a line perpendicular to the rotation of one or more of the variable frequency generator 494a or the first portion 544. While illustrated as the intersection of the variable frequency generator 494a and the first portion 544 of the AGB 490, the intersection of any one of the set of first accessory devices 494 and the first portion 544 of the AGB 490 are contemplated.

A first angle 595 is measured from the first drive axis 593 to a first line 597 parallel the turbine engine axis of rotation 612 where the first line 597 intersects the first drive axis 593 at the first intersection 577. The first angle 595 can be in a range from −50° to 50°. A positive angle, as illustrated by way of example, can be formed from the first drive axis 593 extending from the aft 616 of one or more of the set of first accessory devices 494, or the first portion 544, where the first angle 595 is measured in a clockwise direction or downward from the from the first line 597 to the first drive axis 593. A negative angle can be formed from the first drive axis 593 extending from the aft 616 of one or more of the set of first accessory devices 494, or the first portion 544, where the first angle 595 is measured in a counterclockwise direction or upward from the from the first line 597 to the first drive axis 593.

It is contemplated that the first angle 595 is non-zero. That is, the first angle 595 can be in a range from −50° to less than 0° and greater than 0° to less than or equal to 50°. That is, one or more first accessory devices of the set of first accessory devices 494, the first portion 544, or combination thereof includes a rotatable axis that is tilted or angled with respect to the turbine engine axis of rotation 612. For example, the variable frequency generator 494a is angled with respect to the turbine engine axis of rotation 612. It is further contemplated that the first angle 595 is in a range from greater than 0° to 50°.

Benefits of an angled portion of one or more of the set of first accessory devices 494, the first portion 544, or combination thereof include allowing for more compact packaging of components in the inner cowl space 81 (FIG. 6). For example, the tilted or angled portion of the one or more of the set of first accessory devices 494, the first portion 544, or combination thereof can improve the routing of pipes. The tilted or angled portion(s) can result in fewer bends in one or more pipes which can lead to less pressure drop within the pipe(s). Additionally, or alternatively, the pipes can be shorter, which can provide pressure benefits, weight benefits, cost benefits, or any combination thereof.

Another benefit of the tilted or angled portion(s) of the one or more of the set of first accessory devices 494, the first portion 544, or combination thereof can be to improve the aerodynamics or reduce the drag of the inner cowl 76 (FIG. 6), the outer cowl 82 (FIG. 6) or a combination thereof.

The second accessory device 502, illustrated as the lubrication pump, operably couples to the second portion 546 of the AGB 490. A second intersection 677 is defined by the intersection of the second accessory device 502 and the second portion 546 of the AGB 490. A second drive axis 693 can be defined by a line parallel to the rotation of one or more of the second accessory device 502 or the second portion 546. The second drive axis 693 can be defined at the second intersection 677. Alternatively, it is contemplated that the second drive axis 693 can be defined by a line perpendicular to the rotation of one or more of the second accessory device 502 or the second portion 546.

A second angle 695 is measured from the second drive axis 693 to a second line 697 perpendicular to the turbine engine axis of rotation 612 where the second line 697 intersects the second drive axis 693 at the second intersection 677.

The second angle 695 can be in a range from −90° to 90°. For example, the second angle 695 can be in a range from −50° to 50°. A positive angle, as illustrated by way of example, can be formed from the second drive axis 693 extending from the second accessory device 502 or the second portion 546, where the second angle 695 is measured in a clockwise direction or forward from the from the second line 697 to the second drive axis 693. A negative angle can be formed from the second drive axis 693 extending from the second accessory device 502 or the second portion 546, where the second angle 695 is measured in a counterclockwise direction or aft from the from the second line 697 to the second drive axis 693.

It is contemplated that the second angle 695 is non-zero. That is, the second angle 695 can be in a range from −50° to less than 0° and greater than 0° to less than or equal to 50°. That is, the second accessory device 502 or the second portion 546, or combination thereof includes a rotatable axis that is tilted or angled with respect to a line drawn perpendicular to the turbine engine axis of rotation 612. It is further contemplated that the second angle 695 is in a range from greater than 0° to 50°.

In other words, the second drive axis 693 can be is angled with respect to a line perpendicular to the turbine engine axis of rotation 612. In other words, the second portion 546 of the AGB 490, the second accessory device 502, or both shift or slope axially forward 614 (or aft 616) as they extend in the radial direction (R). It is contemplated that any one or more portions of the first portion 544, the second portion 546, the set of first accessory devices 494, the second accessory device 502, or other assemblies coupled to the AGB 490 can be angled or have a rotational axis angled (at a non-zero angle) with respect to the turbine engine axis of rotation 612 or lines drawn perpendicular to the turbine engine axis of rotation 612.

While the first angle 595 is illustrated, by way of example, as equal to the second angle 695, it is contemplated that the first angle 595 is different than the second angle 695. The bevel gear system 583 (FIG. 6) allows the first drive axis 593 of the first portion 544 of the AGB 490 to be at a non-zero angle relative to the second drive axis 693 of the second portion 546 of the AGB 490. As illustrated, by way of non-limiting example, the angle between the first drive axis 593 and the second drive axis 693 is 90°, although other angles are contemplated.

Benefits of the second angle 695 having a non-zero value can include improved packaging of components in the inner cowl space 81 (FIG. 6). That is, the components in the inner cowl space 81 can have a more compact configuration. Another benefit of the tilted or angled portion(s) of the second accessory device 502 or the second portion 546, or combination thereof can be to improve the aerodynamics or reduce the drag of the inner cowl 76 (FIG. 6), the outer cowl 82 (FIG. 6) or a combination thereof.

A fuel plate 700 can be coupled to one or more portions of the AGB 490. While illustrated as being aft of the AGB 490, it is contemplated that the fuel plate 700 can partially axially overlap of the AGB 490, be located at least partially forward of the AGB 490, or any combination thereof.

The fuel plate 700 can structurally mount, operably mount, or a combination of structurally and operably couple a set of fuel accessories 702 to the AGB 490. The set of fuel accessories 702 can include, by way of example, the fuel pump 494c, a first fuel accessory 702a, a second fuel accessory 702b, and a third fuel accessory 702c. The first fuel accessory 702a, the second fuel accessory 702b, the third fuel accessory 702c, or any combination thereof can be, for example, a fuel heat exchanger. While illustrated as four accessories, any number of accessories are contemplated in the set of fuel accessories 702 coupled to the fuel plate 700 or located at another location within the turbine engine 600. The fuel plate 700 can provide structure a support, thermal insulation, or a combination thereof for one or more of the set of fuel accessories 702. That is, it is contemplated that the fuel plate 700 can include a cooling system or materials that are thermally resistive.

Optionally, a third accessory device 520 can be coupled to a fan casing 640 in the fan section 618, the LP compressor section 624, or a combination thereof. The third accessory device 520 can be any number of accessory devices. The third accessory device 520 can be operably coupled to the first portion 544 and/or the second portion 546 of the AGB 490. Additionally, or alternatively, the third accessory device 520 can be coupled to additional gearing or another gearbox.

Benefits of aspects of the disclosure include improved overall fuel efficiency. The unique design reflects a desirable trade between the benefit of overall fuel efficiency verses the penalties of electing to use two gearboxes. That is, using two gearboxes, where the primary gearbox is located in the inner cowl space and the hollow portion of the fairing and the mini gearbox is located in the outer cowl space, along with placing larger accessories in the inner cowl space or the hollow portion of the fairing with smaller accessories located in the outer cowl provides the unexpected solution of improved overall fuel efficiency.

Benefits of locating the first accessory device (or the set of first accessory devices) and the second accessory device within the inner cowl and fairing (instead of in the outer cowl) reduces the length of the communication lines, fluid lines, or other connecting components to aircraft systems or the engine core. Shortening the communication lines, fluid lines, or other connecting components can reduce weight carried by the aircraft. Further, shortening the communication lines, fluid lines, or other connecting components will have a material savings.

Benefits of locating the first accessory device (or the set of first accessory devices) and the second accessory device within the inner cowl space and fairing (instead of in the outer cowl space) improves aerodynamics and weight of the outer cowl and the inner cowl. A thinner, lighter outer cowl can be used and therefore provides a weight savings. Further, the aerodynamics of the outer cowl and/or the inner cowl can be improved. That is, the inner and outer cowls can be smaller and/or more streamlined or aerodynamic when the first accessory device (or the set of first accessory devices) and the second accessory device are within the inner cowl and fairing instead of in the outer cowl. The improved airflow through the cowls and improved aerodynamic lines improves fuel efficiency.

Further, the unique location of the first, second, and third accessories can provide for a slim line nacelle fan cowl.

The split configuration of the accessories provides a maintenance advantage. That is, not placing the first, second, and third accessories all in the inner cowl space makes it easier to access each accessory. As compared to a fully core AGB with accessories, the split configuration reduces the number (or density) of accessories in the inner cowl space; which can make it easier to provide maintenance to the first accessory or set of first accessories. Further, the hollow portion of the fairing as well as the outer cowl space are known to be accessible spaces to provide maintenance. Therefore, maintenance to the second accessory and the third accessory or third set of accessories is improved when compared to a fully core AGB with accessories.

The configuration of the mini AGB with select accessories in the outer cowl provides a cooler environment for the operation of the mini AGB and attached accessories. While the inner cowl and fairing are a warmer environment, a temperature benefit can still be had by locating the AGB1 and attached accessories upstream of the combustion section.

Therefore, aspects of the disclosure simultaneously improve fuel burn by facilitating a tight aerodynamic cowl line package around the engine core and fan while balancing environment temperature and maintenance access.

Benefits of the accessory gearbox with the single arm include a compact configuration that minimizes fluid lines and other connecting aspects between the engine core and the accessory gearbox, the accessory devices, or both. The compact configuration can also allow for a narrower inner cowl, outer cowl, or combination therefore. Additionally, or alternatively to the smaller diameters of the inner cowl and/or the outer cowl, the axial length of the turbine engine can be reduced, which improves fuel efficiency.

Locating the lubrication pump in the bifurcation (fairing) contributes to the compact configuration. The accessory gearbox extending from the inner cowl space to the hollow portion enable locating the accessory device in the fairing. That is, gears from the inner cowl can drive the lubrication pump at an interface of the lubrication pump and the second portion of the accessory gearbox. The unique accessory gearbox design allows for the circumferential placement of the first set of accessories about a portion of the engine casing while also driving the second accessory device in the fairing.

Locating the lubrication pump in the fairing improves oil flow at start due to head pressure. That is, the lower the lubrication pump is located in the engine relative to the tank, the better the lubrication system and engine performs.

The single arm improves maintenance and accessibility with the first set of accessories being located between the boundary of the fairing and an upper fairing or upper portion of the turbine engine.

Benefits of a non-zero first angle or second angle can include better packaging that can include minimizing fluid line. Minimizing fluid line length decreases weight. The fluid lines can also be shorter, which saves weight and decreases pressure drop in the fluid line or tube, which improves lubrication system performance and can increase engine efficiency.

Further aspects of the disclosure are provided by the subject matter of the following clauses:

A turbine engine comprising a fan section, a compressor section, a combustion section, and a turbine section in axial flow arrangement and defining a turbine engine axis of rotation, wherein the compressor section comprises a low-pressure compressor and a high-pressure compressor, an engine core defined by the compressor section, the combustion section, and the turbine section, an inner cowl circumscribing at least a portion of the engine core and radially spaced from the engine core to define an inner cowl space, an outer cowl circumscribing at least a portion of the inner cowl and spaced from the inner cowl, wherein the outer cowl includes a radially outer surface spaced from a radially inner surface to define an outer cowl space, a fairing extending radially between the inner cowl and the outer cowl having at least a hollow portion, a first accessory gearbox having a first portion located in the inner cowl space and a second portion, extending from the first portion, located in the hollow portion of the fairing, a first accessory device located in the inner cowl space and operably coupled to the first portion of the first accessory gearbox, a second accessory device located in the hollow portion of the fairing and operably coupled to the second portion of the first accessory gearbox, a second accessory gearbox located in the outer cowl space and operably coupled to the first accessory gearbox, and a third accessory device operably coupled to the second accessory gearbox and located in the outer cowl space.

A turbine engine comprising a fan section, a compressor section, a combustion section, and a turbine section in axial flow arrangement and defining a turbine engine axis of rotation, wherein the compressor section comprises a low-pressure compressor and a high-pressure compressor, an engine core defined by the compressor section, the combustion section, and the turbine section, an inner cowl circumscribing at least a portion of the engine core and radially spaced from the engine core to define an inner cowl space, an outer cowl circumscribing at least a portion of the inner cowl and spaced from the inner cowl, wherein the outer cowl includes a radially outer surface spaced from a radially inner surface to define an outer cowl space, a fairing extending radially between the inner cowl and the outer cowl having at least a hollow portion, a first accessory gearbox having a first portion located in the inner cowl space and a second portion, extending from the first portion, located in the hollow portion of the fairing, at least two accessories, wherein the at least two accessories are two of an electrical generator, a starter, or a pump operably coupled to the first accessory gearbox, wherein at least one of the at least two accessories is located at least partially in the inner cowl space and the other of the at least two accessories is located at least partially in the hollow portion of the fairing, a second accessory gearbox located in the outer cowl space and operably coupled to the first accessory gearbox, and a third accessory device operably coupled to the second accessory gearbox and located in the outer cowl space.

A turbine engine comprising an engine core defined by a compressor section, a combustion section, and a turbine section, an inner cowl circumscribing at least a portion of the engine core and radially spaced from the engine core to define an inner cowl space, an outer cowl circumscribing at least a portion of the inner cowl and spaced from the inner cowl, a fairing extending radially between the inner cowl and the outer cowl, the fairing defining a hollow portion, an accessory gearbox having a first portion defined by a single arm located in the inner cowl space and a second portion, extending from the first portion, located in the hollow portion of the fairing, a first accessory device located in the inner cowl space and operably coupled to the first portion of the accessory gearbox, and a second accessory device located in the hollow portion of the fairing and operably coupled to the second portion of the accessory gearbox.

The turbine engine of any preceding clause, wherein the first accessory device includes at least one of a variable frequency generator, a hydraulic pump, and a starter.

The turbine engine of any preceding clause, wherein the second accessory device is a lubrication pump.

The turbine engine of any of the preceding clauses, wherein the third accessory device is one or more of a fuel pump, a permanent magnet alternator, or an engine turning motor.

The turbine engine of any preceding clause, wherein the second accessory device is a lubrication pump and the third accessory device is a fuel pump, a permanent magnet alternator, or an engine turning motor.

The turbine engine of any preceding clause, wherein the second accessory gearbox is a mini accessory gearbox.

The turbine engine of any preceding clause, wherein the mini accessory gearbox is located forward of the first accessory gearbox.

The turbine engine of any preceding clause, wherein the third accessory device coupled to the mini accessory gearbox is a fuel pump, a permanent magnet alternator, or an engine turning motor.

The turbine engine of any preceding clause, wherein a volume of the mini accessory gearbox is in a range from 10% to 80% of a volume of the first accessory gearbox.

The turbine engine of any preceding clause, wherein a volume of the mini accessory gearbox is in a range from 15% to 66% of a volume of the first accessory gearbox.

The turbine engine of any preceding clause, wherein a volume of the third accessory device is in a range of 2% to 66% of a volume of the first accessory device or the second accessory device.

The turbine engine of any preceding clause, wherein a volume of the third accessory device is in a range of 2% to 45% of a volume of the first accessory device or the second accessory device.

The turbine engine of any preceding clause, wherein the third accessory device is a set of third accessory devices, where each device of the set of third accessory devices has a volume in a range of 2% to 66% of a volume of the first accessory device or the second accessory device.

The turbine engine of any preceding clause, further comprising at least one shaft operably coupling the first accessory gearbox to the second accessory gearbox.

The turbine engine of any preceding clause, further comprising one or more shafts coupling the engine core to the first accessory gearbox.

The turbine engine of any preceding clause, wherein the one or more shafts couple the engine core to the first accessory gearbox at an intersection of the first portion and the second portion.

The turbine engine of any preceding clause, wherein the second portion of the first accessory gearbox extends from the first portion in the inner cowl space, through the hollow portion of the fairing, and into the outer cowl space.

The turbine engine of any preceding clause, further comprising at least one shaft located at least partially in the outer cowl operably coupling the first accessory gearbox to the second accessory gearbox.

The turbine engine of any preceding clause, wherein the first portion of the first accessory gearbox includes a first arm and a second arm that straddle the engine core.

The turbine engine of any preceding clause, wherein the second accessory gearbox is axially located in the fan section or radially outward of the low-pressure compressor.

The turbine engine of any preceding clause, wherein the fan section includes fan blades rotatable about the turbine engine axis of rotation and circumscribed by a fan casing defined, in part, by the outer cowl, wherein the second accessory gearbox and the third accessory device are coupled to an exterior of the fan casing.

The turbine engine of any preceding clause, wherein the third accessory device axially overlaps the fan casing.

The turbine engine of any preceding clause, wherein the first accessory device is located forward of the combustion section.

The turbine engine of any preceding clause, wherein the second accessory device is located forward of the combustion section.

The turbine engine of any preceding clause, wherein the first accessory device includes at least one of a variable frequency generator, a hydraulic pump, or a starter.

The turbine engine of any preceding clause, wherein the first accessory device is a set of first accessory devices that include a variable frequency generator, a hydraulic pump, and a starter.

The turbine engine of any preceding clause, wherein the second accessory device is a lubrication pump.

The turbine engine of any preceding clause, wherein the fairing includes a transition region, and wherein the lubrication pump is at least partially located in the transition region of the fairing.

The turbine engine of any preceding clause, wherein the fairing includes a transition region, and wherein the second portion of the accessory gearbox couples to the second accessory device within the transition region of the fairing.

The turbine engine of any preceding clause, further comprising one or more shafts coupling the engine core to the accessory gearbox.

The turbine engine of any preceding clause, wherein the single arm includes an arm length measured along a centerline extending from a first circumferential end to a second circumferential end.

The turbine engine of any preceding clause, wherein the arm length of the single arm is in a range from 1% to 80% of a circumference of an engine casing of the engine core, wherein the circumference of the engine casing is measured at an outer surface of the engine casing.

The turbine engine of any preceding clause, wherein the arm length of the single arm is in a range from 5% to 60% of a circumference of an engine casing of the engine core, wherein the circumference of the engine casing is measured at an outer surface of the engine casing.

The turbine engine of any preceding clause, further comprising an upper fairing, wherein the single arm of the first portion is located between the upper fairing and a boundary defined by a portion of the inner cowl at an intersection of the inner cowl space and the hollow portion.

The turbine engine of any preceding clause, wherein the first accessory device is one or more of a variable frequency generator, a hydraulic pump, or a starter.

The turbine engine of any preceding clause, wherein the second accessory device is a lubrication pump.

The turbine engine of any preceding clause, wherein the fairing includes a transition region, and wherein the lubrication pump is at least partially located in the transition region of the fairing.

The turbine engine of any preceding clause, wherein the second portion of the accessory gearbox couples to the lubrication pump within the transition region of the fairing.

The turbine engine of any preceding clause, wherein the first portion or the first accessory device defines a first drive axis and a first angle is measured at an intersection of the first drive axis and a first line parallel to a turbine engine axis of rotation, and wherein the first angle is greater than zero.

The turbine engine of any preceding clause, wherein the second portion or the second accessory device defines a second drive axis and a second angle is measured at the intersection of the second drive axis and a second line perpendicular to the turbine engine axis of rotation, and wherein the second angle is greater than zero.

The turbine engine of any preceding clause, wherein the second angle is in a range of 5° to 30°.

The turbine engine of any preceding clause, wherein the single arm is a C-shape that circumferentially extends about the engine core in a single direction from an intersection of the hollow portion and the inner cowl space.

The turbine engine of any preceding clause, further comprising a fuel plate coupled to the accessory gearbox, wherein a set of fuel accessories are coupled to the fuel plate, and wherein the set of fuel accessories includes at least one of a fuel pump or a fuel heat exchanger.

What is claimed is:

1. A turbine engine comprising:
an engine core defined by a compressor section, a combustion section, and a turbine section;
an inner cowl circumscribing at least a portion of the engine core and radially spaced from the engine core to define an inner cowl space;
an outer cowl circumscribing at least a portion of the inner cowl and spaced from the inner cowl;
a fairing extending radially between the inner cowl and the outer cowl, the fairing defining a hollow portion;
an accessory gearbox having a first portion defined by a single arm located in the inner cowl space and a second portion, extending from the first portion, located in the hollow portion of the fairing;
a first accessory device located in the inner cowl space and operably coupled to the first portion of the accessory gearbox; and
a second accessory device located in the hollow portion of the fairing and operably coupled to the second portion of the accessory gearbox.

2. The turbine engine of claim 1, wherein the first accessory device includes at least one of a variable frequency generator, a hydraulic pump, or a starter.

3. The turbine engine of claim 1, wherein the first accessory device is a set of first accessory devices that include a variable frequency generator, a hydraulic pump, and a starter.

4. The turbine engine of claim 1, wherein the second accessory device is a lubrication pump.

5. The turbine engine of claim 4, wherein the fairing includes a transition region, and wherein the lubrication pump is at least partially located in the transition region of the fairing.

6. The turbine engine of claim 1, wherein the fairing includes a transition region, and wherein the second portion of the accessory gearbox couples to the second accessory device within the transition region of the fairing.

7. The turbine engine of claim 1, further comprising one or more shafts coupling the engine core to the accessory gearbox.

8. The turbine engine of claim 1, wherein the single arm includes an arm length measured along a centerline extending from a first circumferential end to a second circumferential end.

9. The turbine engine of claim 8, wherein the arm length of the single arm is in a range from 1% to 80% of a circumference of an engine casing of the engine core, wherein the circumference of the engine casing is measured at an outer surface of the engine casing.

10. The turbine engine of claim 8, wherein the arm length of the single arm is in a range from 5% to 60% of a circumference of an engine casing of the engine core, wherein the circumference of the engine casing is measured at an outer surface of the engine casing.

11. The turbine engine of claim 1, further comprising an upper fairing, wherein the single arm of the first portion is located between the upper fairing and a boundary defined by a portion of the inner cowl at an intersection of the inner cowl space and the hollow portion.

12. The turbine engine of claim 11, wherein the first accessory device is one or more of a variable frequency generator, a hydraulic pump, or a starter.

13. The turbine engine of claim 12, wherein the second accessory device is a lubrication pump.

14. The turbine engine of claim 13, wherein the fairing includes a transition region, and wherein the lubrication pump is at least partially located in the transition region of the fairing.

15. The turbine engine of claim 14, wherein the second portion of the accessory gearbox couples to the lubrication pump within the transition region of the fairing.

16. The turbine engine of claim 1, wherein the first portion or the first accessory device defines a first drive axis and a first angle is measured at an intersection of the first drive axis and a first line parallel to a turbine engine axis of rotation, and wherein the first angle is greater than zero.

17. The turbine engine of claim 16, wherein the second portion or the second accessory device defines a second drive axis and a second angle is measured at the intersection of the second drive axis and a second line perpendicular to the turbine engine axis of rotation, and wherein the second angle is greater than zero.

18. The turbine engine of claim 17, wherein the second angle is in a range of 5° to 30°.

19. The turbine engine of claim 1, wherein the single arm is a C-shape that circumferentially extends about the engine core in a single direction from an intersection of the hollow portion and the inner cowl space.

20. The turbine engine of claim 1, further comprising a fuel plate coupled to the accessory gearbox, wherein a set of fuel accessories are coupled to the fuel plate, and wherein the set of fuel accessories includes at least one of a fuel pump or a fuel heat exchanger.
